(19) United States
(12) Patent Application Publication
(10) Pub. No.: US 2008/0162458 A1
(43) Pub. Date: Jul. 3, 2008

(54) Dynamic construction of selection screens

(75) Inventors: Wolfgang E. Walter, Hambruecken (DE); Amar Kumar, Rauenburg (DE)

Correspondence Address: SAP/BLAKELY, 1279 OAKMEAD PARKWAY, SUNNYVALE, CA, 94085-4040, US

(73) Assignee: SAP AG

(21) Appl. No.: 11/648,492

(22) Filed: Dec. 28, 2006

(51) Int. Cl. G06F 17/30

(52) U.S. Cl. 707/5; 707/E17.017

(57) ABSTRACT

A database customizing method accepts choices of database field identifiers and associates a matching method with each identifier, then automatically displays a selection dialog to parameterize a database search on the field identifiers. Related software and systems are also discussed.

### FIELD

The invention relates to user interfaces for database interaction. More specifically, the invention relates to automatic methods for producing database selection screens.

### BACKGROUND

Commercially-available databases are often designed to store arbitrary types and quantities of data, so that a single, flexible database engine can be used in many different applications. However, even within a relatively narrow field of endeavor (e.g. supply chain management or medical practice accounting), two different database users may have different requirements for effective integration of the database into their business operations. Such requirements are traditionally satisfied through database customization, where an engineer configures database operational parameters and writes software to adapt the database's capabilities to the business's needs.

Database customization can be expensive and time-consuming, and sometimes requires special training and experience to perform correctly. Therefore, some businesses must make do with a generic configuration and functionality, or with a system that has become outdated with respect to the business's present needs. Database systems and methods that can be configured and customized more flexibly (and by users with less special training) may be valuable to the businesses that use them.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 shows a sample user interface for creating a dynamic selection screen.

FIG. 2 shows a sample selection screen created automatically from entries made on a dynamic selection screen creation interface.

FIG. 3 outlines a method of collecting information to create a dynamic selection screen, and then automatically creating the screen.

FIG. 4 shows how dynamic selection screens created by an automatic process can be presented and operated.

FIG. 5 shows some components of a computer system that implements an embodiment of the invention.

### DETAILED DESCRIPTION

Embodiments of the invention present a menu of related data fields in a database and accept a selection of a subset of the fields. Each selected field is associated with a matching style, and the selections and matching styles are saved as a dynamic selection screen definition. Later, the dynamic selection screen is displayed, and a user can enter values to parameterize a database search. Some embodiments can also produce dynamic selection screens from automatically-generated field and matching-style definitions.

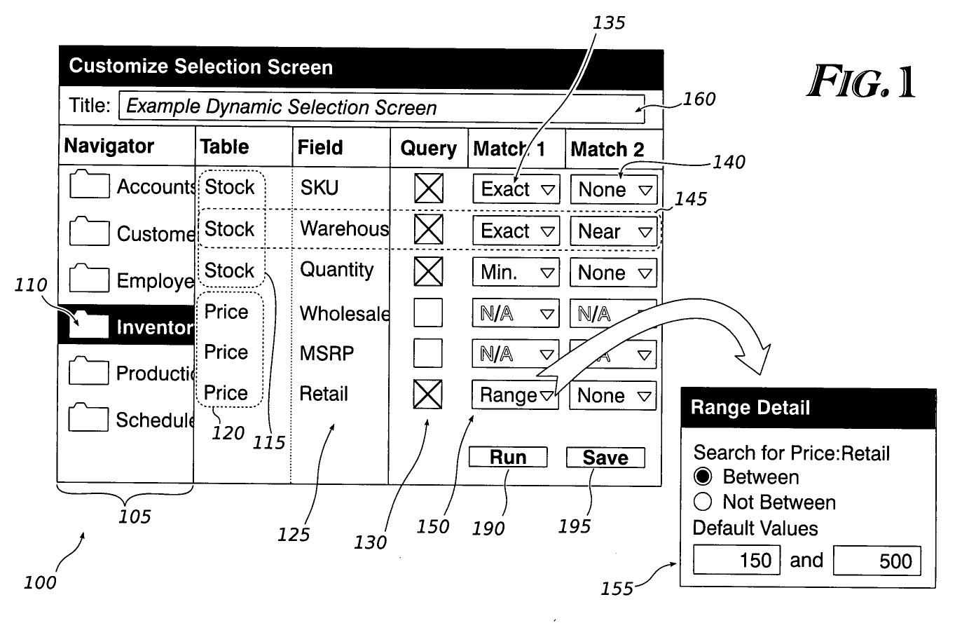

FIG. 1 shows a sample database user interface screen 100. A “navigator” pane 105 permits the user to browse the classes or categories of information stored in the database. When one category 110 is selected, related tables 115, 120 and fields in those tables 125 are displayed. The user can select some of the fields using, in this example, checkboxes 130. For each selected field, the user can specify one or more matching styles through drop-down menus 135 and 140. This sample display shows that entry 145, related to a “warehouse” field of a “stock” table, is to be searchable via an exact-match field and via a geographical proximity (“Near”) field.

Some matching styles may require additional information to configure a search. For example, when the “Range” matching style 150 is selected for searches on the “retail” field of the “price” table, a detail window 155 may be displayed to collect more information from the user. Some embodiments may collect general information about the selection screen as well, such as a title 160 to be displayed when the dynamic selection screen is invoked. Once the user makes his choices, the selection screen may be invoked immediately via the “Run” control 165, or saved for future use with the “Save” control 170.

The monochrome, limited resolution format of the accompanying figures is poorly suited to illustrating the powerful user interface an embodiment can present by using color and dynamic content on a contemporary computer display. However, the following descriptions of features offered by some embodiments are adequate to permit one of skill in the art to produce a dynamic selection screen interface according to an aspect of the invention. Like the simple “between” and “not between” choice presented in range detail screen 155, an embodiment can offer some or all of the following matching method modifiers: matching multiple separate values or ranges; retrieving default values for some fields from the database; selection of records that do not match the criteria (rather than those that do match); and loose or flexible matching (for example, case insensitive text matching). In addition, an embodiment can permit the user to make certain selection criteria mandatory (i.e. the query cannot be executed unless the criterion is specified). A first match field can be associated with a second match field, so that an entry in one field automatically updates the other field. As a simple example of this, in a minimum/maximum range field, entering a value into the minimum field that is larger than the currently-entered maximum value may cause the maximum value to be increased to the newly-entered value.

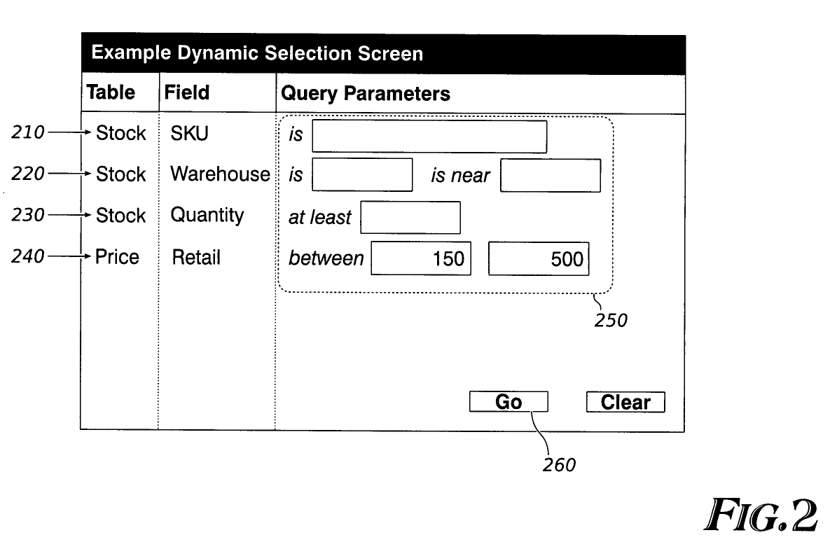

FIG. 2 shows a sample selection screen that could be produced automatically from the selections shown in FIG. 1. Rows 210, 220, 230 and 240 correspond to the database fields chosen by checkboxes 150, and the query parameter entry fields indicated within dashed-box 250 correspond to the matching methods selected in columns 160 and 170. In this sample, the arrangement of database fields and query parameter entry fields is automatically determined by an embodiment of the invention. Some embodiments may permit the user who configures the dynamic search to specify the arrangement or appearance of fields also. After values have been entered into some or all of the parameter entry fields, the “Go” control 260 can be used to cause the database to execute the parameterized search and to display any results found.

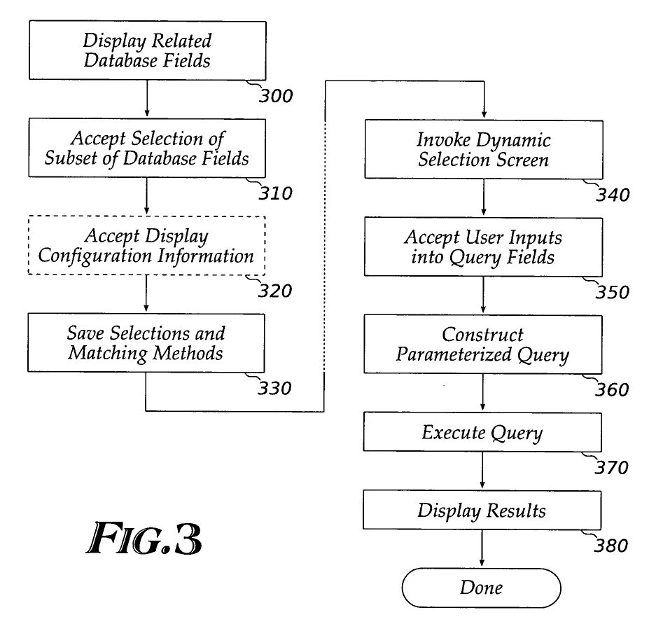

FIG. 3 outlines a method that some embodiments use to create dynamic selection screens. First, a plurality of related database fields are displayed (300). The fields may be columns of a single table or view, or may be columns of multiple tables, where the embodiment can identify common keys that permit records in the multiple tables to be correlated for a parameterized search. For example, a database may be structured so that a “Customer” table holds some information about a customer, while a “Customer_Address” table holds information about one or more addresses that can be used to reach the customer. An embodiment may consider “Customer” fields and “Customer_Address” fields to be related.

Next, a user's selections of a subset of the related database fields are accepted (310). Some systems can automatically produce selection screens for all of the related database fields, so embodiments may be particularly useful when the user only wants to parameterize a query on a proper subset (i.e. fewer than all) of the related database fields. An embodiment can use a graphical user interface (“GUI”) similar to that shown in FIG. 1 to accept these field selections. Each field selection includes a choice of one or more matching methods that will be used in a parameterized search constructed from the dynamic selection screen. For example, a text field may be specified for exact matching or partial string (substring) matching. A numeric field might be specified for exact matching, minimum or maximum value matching (match records with values either larger than or smaller than a specified value), or range matching (both inclusive ranges and exclusive ranges). Specialty match methods may also be provided. For example, a field that indicates a geographical location (such as a postal code field or an address field) can be matched based on its proximity to the search parameter location.

Some fields may be associated with more than one matching method to permit greater flexibility when the dynamic selection screen is used. For example, a numeric field might be associated with all of “minimum,” “maximum” and “range” match methods. This would permit the dynamic selection screen to control a wider range of searches.

Next, some (but not all) embodiments collect information to affect the presentation of the dynamic selection screen (320). For example, an embodiment may automatically produce a sample default selection screen like that shown in FIG. 2, then permit the user to “drag” labels and entry fields to desired locations on the display. The selected fields, matching methods and (if appropriate) display locations may be saved (330) as a dynamic selection screen. An embodiment may save this information in any convenient format, but for some applications, a text-based format such as Extensible Markup Language (“XML”) permits an alternate usage model, as discussed below.

Later, the saved dynamic selection screen is invoked or executed (340). For example, screens may be saved with, and selected by, a name or other identifier. When the screen is invoked, the system displays labels and query entry fields and accepts user input into those fields (350). When the user indicates that he is satisfied with the entries (for example, by activating a “Go” control 260), the user input is used to construct a parameterized database query (360). The query is executed (370) and any results are displayed to the user (380). Note that in some embodiments, the dynamic selection screen configuration is not saved. Instead, the configured screen is invoked immediately and used to parameterize a search.

Databases whose functionality can be customized using add-on software usually offer an Application Program Interface (“API”) that developers use to permit their software to control and/or interact with the database. An embodiment of the invention can include a code generator which automatically produces software based on the selected fields and matching methods. The software may be in “source code” form, suitable for further modification, or in a binary, “executable” form that can be interpreted or executed by a programmable processor.

An embodiment that stores user selections to describe a dynamic selection screen in a text-based format such as XML, may be able to accept XML selections created by other processes as well. For example, a first user can configure a dynamic selection screen as discussed above, and then send the XML description to a second user. The second user can invoke or execute the XML description through his database and perform the query designed by the first user. XML descriptions of dynamic selection screens may also be prepared by an automatic or autonomous process such as a computer program.

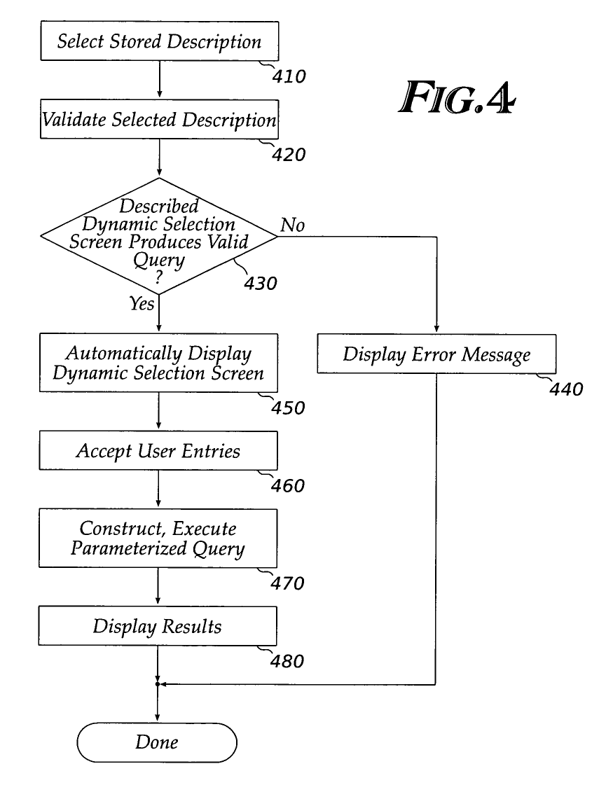

FIG. 4 outlines a method by which an embodiment of the invention can use an XML (or similar textual) description of a dynamic selection screen. A user may select one of several stored descriptions (410) through a menu or similar user interface mechanism. The selected description is validated (420) to ensure that it is correctly structured and that it will produce a query that can be performed by the database. For example, a selection screen that was configured by a first person at a first database may not be useable by a second person or at a second database because the second person lacks access rights to query certain tables, or the second database lacks the tables entirely.

If the described dynamic selection screen will not produce a valid query (430), an error message may be displayed (440). Otherwise, a dynamic selection screen corresponding to the selected description is automatically displayed (450) and user entries into the query fields are accepted (460). A parameterized query is constructed based on the user's entries and then executed (470). Results of the query are then displayed (480).

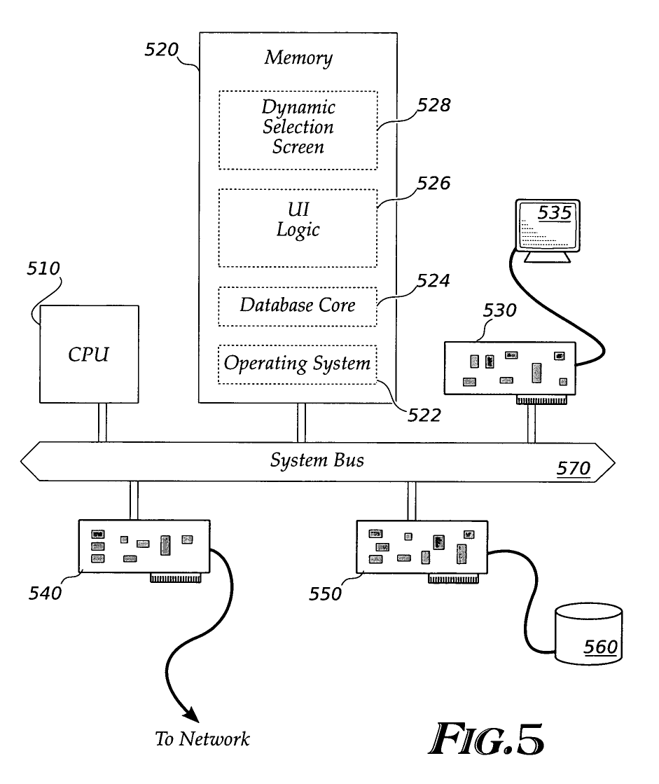

FIG. 5 shows some subsystems of a computer system that implements an embodiment of the invention. Central processing unit or “CPU” 510 is a programmable processor for executing instructions in memory 520; the instructions cause the processor to perform methods according to embodiments of the invention. Instructions in memory 520 may include an operating system 522 to control the low-level operations of the computer, database core logic 524 to implement data storage, query and record retrieval; user interface (“UI”) logic 526 to interact with a user, and dynamic selection screen logic 528 to operate as described above. Dynamic selection screen logic 520 may include a customization logic portion to associate subsets of related database field identifiers with selection methods, and query logic to automatically present a dynamic selection screen based on information collected by the customization logic. A video interface 530 produces signals to display text and graphics on monitor 535. Network interface 540 permits the system to communicate with other cooperating systems over a local area network (“LAN,” not shown); a wide-area network (“WAN,” not shown) or another distributed data network such as the Internet. A mass storage interface 550 permits the system to read and write data on a storage device such as hard disk 560. In some embodiments, database core logic 524 stores a database schema describing related tables, and the data in those tables, on hard disk 560. These components, and others that are not shown here, exchange commands and data through a system bus 570.

An embodiment of the invention may be a machine-readable medium having stored thereon instructions which cause a programmable processor to perform operations as described above. In other embodiments, the operations might be performed by specific hardware components that contain hardwired logic. Those operations might alternatively be performed by any combination of programmed computer components and custom hardware components.

A machine-readable medium may include any mechanism for storing or transmitting information in a form readable by a machine (e.g., a computer), including but not limited to Compact Disc Read-Only Memory (CD-ROM), Read-Only Memory (ROM), Random Access Memory (RAM), and Erasable Programmable Read-Only Memory (EPROM).

The applications of the present invention have been described largely by reference to specific examples and in terms of particular allocations of functionality to certain hardware and/or software components. However, those of skill in the art will recognize that customized database selection screens can also be produced by software and hardware that distribute the functions of embodiments of this invention differently than herein described. Such variations and implementations are understood to be captured according to the following claims.

We claim:

1. A method comprising:
accepting choices of a plurality of database field identifiers and a matching method associated with each field identifier; and
automatically displaying a selection dialog to parameterize a search on the field identifiers, the selection dialog to be prepared according to the choices and associated matching methods.

2. The method of claim 1 wherein the plurality of database field identifiers is a proper subset of a second plurality of database fields to be returned by the search.

3. The method of claim 1 wherein two different selection methods are associated with a database field identifier.

4. The method of claim 1, further comprising:
storing the choices at a first time; and
automatically displaying the selection dialog at a second, later time.

5. The method of claim 1, further comprising:
designating a display location for an entry field associated with one of the field identifiers.

6. The method of claim 1 wherein the selection method is one of a matching entry, a matching set, or a range.

7. The method of claim 1 wherein the selection method specifies either inclusive or exclusive matching.

8. A computer-readable medium containing instructions to cause a programmable processor to perform operations comprising:
displaying a menu containing a plurality of related database field identifiers;
accepting at least one identification of one of the plurality of related database field identifiers, the identification to be associated with a matching method; and
storing the at least one identification as a custom selection screen.

9. The computer-readable medium of claim 8, containing additional instructions to cause the programmable processor to perform operations comprising:
automatically displaying the custom selection screen;
accepting entries corresponding to the at least one database field identifier; and
performing a parameterized query based on the entries.

10. The computer-readable medium of claim 8 wherein the menu includes a table name, a field name, a check box and a matching-method selector for each database field identifier.

11. The computer-readable medium of claim 10 wherein the menu includes a plurality of matching-method selectors for each database field identifier.

12. The computer-readable medium of claim 8 wherein the at least one identification is stored in a text-based format.

13. The computer-readable medium of claim 12 wherein the text-based format is an Extensible Markup Language (“XML”) format.

14. The computer-readable medium of claim 8 containing additional instructions to cause the programmable processor to perform operations comprising:
automatically displaying a second custom selection screen based on a second identification of database fields, wherein the second identification is produced by an autonomous process.

15. A system comprising:
a database containing a plurality of related tables;
a user interface to interact with a user;
customization logic to associate a subset of related database field identifiers with selection methods; and
query logic to automatically present a customized selection screen through the user interface, based on the subset of related database field identifiers associated with selection methods.

16. The system of claim 15 wherein the customization logic is to produce an Extensible Markup Language (“XML”) document describing the subset of related database field identifiers and selection methods.

17. The system of claim 15 wherein a database field identifier is associated with a plurality of selection methods.

18. The system of claim 15 wherein a selection method is a geographical proximity selection method.
